(19) United States
(12) Patent Application Publication
(10) Pub. No.: US 2011/0015072 A1
(43) Pub. Date: Jan. 20, 2011

(54) Microcapsules with Acylurea Walls

(75) Inventors: Maria Teresa Hechavarria Fonseca, Buerstadt (DE); Marc Rudolf Jung, Worms (DE)

Correspondence Address: BRINKS, HOFER, GILSON & LIONE, P.O. BOX 110285, RESEARCH TRIANGLE PARK, NC, 27709, US

(73) Assignee: BASF SE, Ludwigshafen (DE)

(21) Appl. No.: 12/921,282

(22) PCT Filed: Mar. 9, 2009
(86) PCT No.: PCT/EP09/52744

§ 371 Date: Sep. 7, 2010

(30) Foreign Application Priority Data
Mar. 11, 2008 (EP) 08152581.8
Dec. 18, 2008 (EP) 08172145.8

(51) Int. Cl. A01N 43/46; A01N 25/28; A01N 59/00; A01P 13/00; A01P 7/04; A01P 3/00

(52) U.S. Cl. 504/227; 424/451; 424/600

(57) ABSTRACT

The present invention relates to a process for producing microcapsules with a capsule wall and a capsule core, comprising the process steps:
a) preparation of an oil-in-water emulsion with a disperse phase which comprises the core material and an oligocarbodiimide, an aqueous continuous phase and a protective colloid and
b) subsequent reaction of one or more di- and/or polycarboxylic acids and/or water-soluble salts thereof with the oligocarbodiimide,
   and to microcapsules obtainable by this process.

The present invention relates to microcapsules with acylurea walls, to processes for producing them and to their use as latent heat storage materials or in applications in which the capsule core material is to be released by diffusion or targeted mechanical or thermal destruction.

Microcapsules are known in a wide variety of embodiments and are used for different purposes depending on the tightness of the capsule wall. For example, they serve to protect core materials. Microcapsules of this type comprise, for example, latent heat storage materials, often also referred to as PCM (phase change material), the mode of function of which is based on the fact that the solid/liquid phase transition signifies, on account of the transformation enthalpy, an absorption of energy or release of energy to the surrounding area. They can consequently be used for keeping a temperature constant within a fixed temperature range.

Core materials are also known which are intended to be released only as a result of targeted mechanical destruction of the capsule wall, such as dyes for copy papers or encapsulated fragrances.

Furthermore, materials are known which are released for example by diffusion from the microcapsule in a delayed manner, for example biocides.

In these fields of application, capsule wall materials based on gelatin, polyurethane and polyurea and also based on polyacrylates and polymethacrylates are known.

Another option for release is by the thermal route, as described in DE 10 2007 055813, which teaches the release of carbodiimides from microcapsules with walls based on polymethacrylate for laminating adhesives.

Finally, the earlier European application with the application number 07122407.5 teaches the release of adhesive resins from microcapsules through irradiation. Absorbers for IR or microwave radiation are incorporated into the polyurethane-based capsule walls described here and, upon irradiation, lead to softening of the capsule wall and release of the adhesive resin.

Microcapsules with polyurethane-based walls are known widely. For example, DE 26 19 524 teaches the production of microcapsules by dissolving a film-forming polycarbodiimide with functional isocyanate end groups in an inert solvent, admixing with a core material and mixing with an aqueous phase which comprises a water-soluble tertiary amine in catalytic amounts. This gives a polymer shell with polyurea groups as crosslinking sites.

However, encapsulations with isocyanates have disadvantages. In particular, the toxicity of isocyanates hinders the synthesis and limits the application. Moreover, isocyanates react with water. However, since microcapsules are often prepared from aqueous emulsions, the saponification reaction with water leads to starting conditions for the encapsulation process that are difficult to control and makes the result highly dependent on the route of the preparation of the emulsion. Consequently, transferring processes to plants with a different geometry is possible only with difficulty.

In addition, DE 10 2004 059 977 describes microcapsules with a dispersion as capsule core. The capsule walls are formed by the reaction of resins comprising acid groups, some of which have been neutralized with an alkanolamine, with a crosslinker, which may also be a carbodiimide.

It was therefore an object of the present invention to find an alternative wall material which is easy to handle and also an advantageous process for producing these microcapsules. Microcapsules with this wall material should if required have a good tightness and offer various options for release of the core material.

It was a further object to provide microcapsules with adhesive components for multicomponent adhesives as core material which release the core material upon heating.

It was a further object to find an alternative wall material which is highly compatible with agrochemical active ingredients as core material and which can be readily incorporated into agrochemical formulations. Microcapsules with this wall material and agrochemical active ingredients as core material should if required have a good tightness and offer various options for release of the agrochemical active ingredient.

Accordingly, a process for producing microcapsules with a capsule wall and a capsule core has been found, comprising the process steps:
a) preparation of an oil-in-water emulsion with a disperse phase which comprises the core material and an oligocarbodiimide, an aqueous continuous phase and a protective colloid and
b) subsequent reaction of one or more di- and/or polycarboxylic acids and/or water-soluble salts thereof with the oligocarbodiimide,
   and also microcapsules obtainable by this process, and their use as latent heat storage materials or in applications in which the capsule core material is to be released by diffusion or targeted mechanical or thermal destruction.

The invention relates to a process for producing microcapsules with a capsule wall and a capsule core, comprising the process steps:
a) preparation of an oil-in-water emulsion with a disperse phase which comprises the core material and an oligocarbodiimide, an aqueous continuous phase and a protective colloid;
b) addition of one or more di- and/or polycarboxylic acids and/or water-soluble salts thereof to the emulsion prepared in a),
   and also microcapsules obtainable by this process, and their use as latent heat storage materials or in applications in which the capsule core material is to be released by diffusion or targeted mechanical or thermal destruction.

The microcapsules according to the invention comprise a capsule core and a capsule wall made of polymer. The capsule core consists predominantly, to more than 95% by weight, of the core material, which may be an individual substance or a substance mixture. The capsule core can either be solid or liquid depending on the temperature. Preferably, the capsule core is liquid at a temperature of 20° C. and atmospheric pressure. Liquid is to be understood as meaning that the core material has a viscosity in accordance with Brookfield of ≦5 Pa·s.

The average particle size of the capsules (by means of light scattering) is 0.5 to 50 μm, preferably 0.5 to 30 μm. The weight ratio of capsule core to capsule wall is generally from 50:50 to 95:5. Preference is given to a core/wall ratio of 70:30 to 93:7.

Depending on the protective colloid selected for the stabilization of the emulsion, it may likewise be a constituent of the microcapsules. Thus, up to 10% by weight, based on the total weight of the microcapsules, may be protective colloid. According to this embodiment, the microcapsules have the protective colloid on the surface of the polymer.

Suitable core materials for the microcapsules are substances that are insoluble to essentially insoluble in water. Here, essentially insoluble in water is to be understood as meaning a solubility of the core material in water of <25 g/l, preferably ≦5 g/l, at 25° C. If the core material is a mixture, this may be in the form of a solution or suspension. Core materials with the aforementioned solubility in water are preferably selected from the group comprising aliphatic and aromatic hydrocarbon compounds, saturated or unsaturated C₆-C₃₀-fatty acids, fatty alcohols, C₆-C₃₀-fatty amines, C₄-C₃₀-mono-, C₄-C₃₀-di- and C₄-C₃₀-polyesters, primary, secondary or tertiary C₄-C₃₀-carboxamides, fatty acid esters, natural and synthetic waxes, halogenated hydrocarbons, natural oils, C₃-C₂₀-ketones, C₃-C₂₀-aldehydes, crosslinkers, adhesive resins and tackifying resins, fragrances and aroma substances, active ingredients, dyes, color formers, catalysts and inhibitors.

By way of example, the following may be mentioned:
a) aliphatic hydrocarbon compounds such as saturated or unsaturated C₆-C₄₀-hydrocarbons which are branched or linear, e.g. such as n-hexane, n-heptane, n-octane, n-nonane, n-decane, n-undecane, n-dodecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, white oils, and cyclic hydrocarbons, e.g. cyclohexane, cyclooctane, cyclodecane;
b) aromatic hydrocarbon compounds such as benzene, naphthalene, biphenyl, o- or m-terphenyl, C₁-C₄₀-alkyl-substituted aromatic hydrocarbons such as dodecylbenzene, tetradecylbenzene, hexadecylbenzene, hexylnaphthalene, decylnaphthalene and diisopropylnaphthalene;
c) saturated or unsaturated C₆-C₃₀-fatty acids such as lauric acid, stearic acid, oleic acid or behenic acid, preferably eutectic mixtures of decanoic acid with e.g. myristic acid, palmitic acid or lauric acid;
d) fatty alcohols such as lauryl alcohol, stearyl alcohol, oleyl alcohol, myristyl alcohol, cetyl alcohol, mixtures such as coconut fatty alcohol, and also the so-called oxo alcohols, which are obtained by hydroformylation of α-olefins and further reactions;
e) C₆-C₃₀-fatty amines, such as decylamine, dodecylamine, tetradecylamine or hexadecylamine;
f) C₄-C₃₀-mono-, C₄-C₃₀-di- and C₄-C₃₀-polyesters, such as C₁-C₁₀-alkyl esters of C₁-C₂₀-carboxylic acids, such as propyl palmitate, methyl stearate or methyl palmitate, and also preferably their eutectic mixtures or methyl cinnamate and primary, secondary or tertiary C₄-C₃₀-carboxamides, such as N-dimethyloctanamide and N-dimethyldecanamide;
g) natural and synthetic waxes, such as montanic acid waxes, montanic ester waxes, carnauba wax, polyethylene wax, oxidized waxes, polyvinyl ether wax, ethylene vinyl acetate wax or hard waxes by Fischer-Tropsch processes;
h) halogenated hydrocarbons, such as chloroparaffin, bromooctadecane, bromopentadecane, bromononadecane, bromoeicosane, bromodocosane;
i) natural oils such as peanut oil and soybean oil;
j) C₃-C₂₀-ketones and C₃-C₂₀-aldehydes;
k) crosslinkers optionally as solution in the aforementioned core materials of groups a) to i) and j), such as aziridines, epoxides, oxazolines, isocyanates, oximes, carbodiimides or other reactive, polyfunctional compounds such as acids, alcohols, alkoxylates and amines;
l) adhesive resins and tackifying resins, if appropriate as solution in the aforementioned core materials of groups a) to i) and j), such as epoxy resins, epoxy-acrylate resins, polyolefin resins; polyurethane prepolymers, silicone resins, natural and synthetic resins, for example hydrocarbon resins, modified colophony resins, pine and terpene resins;
m) fragrances and aroma substances, if appropriate as a mixture in the aforementioned core materials of groups a) to i) and j), as described in WO 01/49817, or in “Flavors and Fragrances”, Ullmann's Encyclopedia of Industrial Chemistry, Wiley-VCH, 2002, to which reference is expressly made;
n) active ingredients such as biocides, active ingredients to counter endo- and ectoparasites, herbicides, fungicides, algaecides, active ingredients to counter animal pests, e.g. insecticides, acaricides, nematicides, molluscicides and active ingredients to counter mites, and also safeners, if appropriate as solution or suspension in the aforementioned core materials of groups a) to i) and j), as described in WO 2006/092409;
o) moreover mixtures of dyes and/or color formers, in the aforementioned core materials of groups a) to i) and j);
q) catalysts and inhibitors, if appropriate as solution in the aforementioned core materials.

The substances of groups a) to h), preferably of group a), if they pass through a phase change, preferably a solid/liquid phase change, in the temperature range from −20 to 120° C., are suitable as phase change materials (PCM), also known as latent heat storage materials. Depending on the temperature range in which the heat storage is desired, the latent heat storage materials are selected as described in WO 2006/018130, to which reference is expressly made. Furthermore, mixtures of these substances are suitable, provided it does not result in a melting point reduction outside of the desired range, or the heat of melting of the mixture becomes too low for a useful application.

Furthermore, it may be advantageous to add to the core materials compounds soluble therein, in order to thus prevent the crystallization delay that sometimes arises with nonpolar substances. As described in U.S. Pat. No. 5,456,852, compounds are advantageously used as addition which have a melting point that is 20 to 120 K higher than the actual core substance. Suitable compounds are the fatty acids, fatty alcohols, fatty amides and also aliphatic hydrocarbon compounds mentioned above as core materials. They are added in amounts of from 0.1 to 10% by weight, based on the capsule core.

Preferred latent heat storage materials are aliphatic hydrocarbons so-called paraffins, particularly preferably pure n-alkanes, n-alkanes with a purity greater than 80% or alkane mixtures as are produced as technical-grade distillate and are commercially available as such. In particular, preference is given to aliphatic hydrocarbons having 14 to 20 carbon atoms, and mixtures thereof.

Further preferred core materials are adhesive resins for two-component adhesives, crosslinkers for two-component adhesives, fragrances and aroma substances, active ingredients, dyes and/or color formers, in each case if appropriate as solution in the aforementioned core materials of groups a) to i) and j).

The core material is particularly preferably a crosslinker for two-component adhesives or an adhesive resin for two-component adhesives. Preferred adhesive resins are, for example, epoxy resins and epoxy-acrylate resins, the starting materials for reactive adhesives.

Epoxy resin adhesives are described in the book by C. A. May “Epoxy resins” second edition, Marcel Dekker, Inc. Suitable epoxy resins are diepoxy or polyepoxy resins, in particular those with an average molecular weight ≦5000 g/mol. They are available e.g. under the name Araldite® from Huntsmann International LLC. Epoxy-acrylate resins are likewise preferred. Preference is given to resins based on glycidyl acrylates and methacrylates. Preferred starting monomers for these resins are glycidyl acrylate and/or glycidyl methacrylate, acrylic esters, styrene, and hydroxyalkyl acrylates. Such products are available under the name Joncryl® ADR from BASF Corp.

Preferred crosslinkers k) are di- and polyfunctional amines with primary, secondary or tertiary amino groups which have a solubility in water of <5 g/l at a temperature of 20° C.

Suitable crosslinkers k) are also diepoxides.

In a further preferred embodiment, at least one core material is an active ingredient n), in particular an agrochemical active ingredient, such as fungicides, insecticides, nematicides, herbicides and safeners. In one embodiment, growth regulators are also suitable agrochemical active ingredients. Mixtures of pesticides from two or more of the aforementioned classes can also be used. The person skilled in the art is familiar with such agrochemical active ingredients, which can be found, for example, in Pesticide Manual, 14th Ed. (2006), The British Crop Protection Council, London. Usually, the core material comprises an agrochemical active ingredient to at least 50% by weight, preferably to at least 70% by weight, particularly preferably to at least 90% by weight, and specifically to at least 98% by weight.

Suitable insecticides are insecticides of the class of carbamates, organophosphates, organochlorine insecticides, phenylpyrazoles, pyrethroids, neonicotinoids, spinosines, avermectins, milbemycines, juvenile hormone analogs, alkyl halides, organotin compounds, nereistoxin analogs, benzoylureas, diacylhydrazines, METI acaricides, and also insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone, or derivatives thereof. Suitable fungicides are fungicides of the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethyl phosphonates, ethylaminothiazole carboxamides, guanidines, hydroxy(2-amino)pyrimidines, hydroxyanilides, imidazoles, imidazolinones, inorganics, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiocarbamates, thiophanates, thiophenecarboxamides, toluamides, triphenyltin compounds, triazines, triazoles. Suitable herbicides are herbicides of the classes of the acetamides, amides, aryloxyphenoxypropionates, benzamides, benzofuran, benzoic acids, benzothiadiazinones, bipyridylium, carbamates, chloroacetamides, chlorocarboxylic aids, cyclohexanediones, dinitroanilines, dinitrophenol, diphenyl ethers, glycines, imidazolinones, isoxazoles, isoxazolidinones, nitriles, N-phenylphthalimides, oxadiazoies, oxazolidinediones, oxyacetamides, phenoxycarboxylic acids, phenyl carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolinones, triazolocarboxamides, triazolopyrimidines, triketones, uracils, ureas.

In a particularly preferred embodiment, the core materials are active ingredients n), in particular agrochemical active ingredients, which have a solubility in water at 20° C. of below 25 g/l, preferably below 5 g/l, specifically below 1 g/l.

The capsule wall consists essentially of poly(acylureas) which are formed from the primary addition product by the reaction of the carbodiimide groups of the oligocarbodiimides (component (I)) with the acid groups of the di- and/or polycarboxylic acids (component (II)) as a result of intramolecular rearrangement.

Advantageous carbodiimides generally comprise on average 2 to 20, preferably 2 to 15, particularly preferably 2 to 10, carbodiimide groups. The number-average molecular weight Mₙ of the carbodiimide compounds is preferably 100 to 40 000, particularly preferably 200 to 15 000 and very particularly 500 to 10 000 g/mol. The number-average molecular weight can, if the carbodiimides are isocyanate-group-containing carbodiimides, be determined by end-group analysis of the isocyanate groups. If an end-group analysis is not possible, the molecular weight can be determined by gel permeation chromatography (polystyrene standard, THF as eluent).

Carbodiimide groups are obtainable in a generally known manner from two isocyanate groups with elimination of carbon dioxide:

—R—N═C═O+O═C═N—R′—→—R—N═C═N—R′—+CO₂

Starting from polyisocyanates, or diisocyanates, it is possible in this way to obtain carbodiimides with two or more carbodiimide groups and, if appropriate, isocyanate groups, in particular terminal isocyanate groups. Reactions of this type are described for example in Henri Ulrich, Chemistry and Technology of Carbodiimides, John Wiley and Sons, Chichester 2007 and the literature references cited therein, to which reference is expressly made.

The preparation of suitable carbodiimides takes place essentially by two reaction steps. Firstly, (1) carbodiimide structures are produced by a generally known reaction of the isocyanate groups with one another with elimination of carbon dioxide in the presence of customary catalysts, which are known for this reaction, and secondly (2) any isocyanate groups present are reacted with compounds reactive towards isocyanates to produce urethane and/or urea structures.

This gives rise to two process variants. In the first variant (A), first process step (1) is carried out, followed by process step (2). According to variant (B), prior to process step (1), an additional part step is also inserted, in which some of the isocyanate groups are already reacted with isocyanate-reactive compounds, followed by process step (1) and then step (2).

According to process variant (B), firstly up to 50% by weight, preferably up to 23% by weight, of the isocyanate groups of the polyisocyanate are reacted with the compounds reactive towards isocyanates and then the free isocyanate groups are completely or partially condensed in the presence of catalysts with the elimination of carbon dioxide to give carbodiimides and/or oligomeric polycarbodiimides. Following the carbodiimide formation, any isocyanate groups present are reacted with the compounds reactive towards isocyanates.

The concluding reaction, in each case, of the free isocyanate groups (step 2) takes place with a molar ratio of the NCO groups of the carbodiimide having isocyanate groups to the isocyanate-reactive groups of usually 10:1 to 0.2:1, preferably 5:1 to 0.5:1, particularly preferably 1:1 to 0.5:1, in particular 1:1. Preferably, at least enough compounds with groups reactive towards isocyanates are used such that the isocyanate groups of the carbodiimide are completely reacted.

The isocyanate-reactive compounds are organic compounds with at least one hydroxy group, with at least one amine group and/or at least one hydroxy group and at least one amine group. For example, the alcohols and amines specified in DE-A 4 318 979 can be used. Moreover, aromatic, araliphatic and/or aliphatic polyols having 2 to 20 carbon atoms can be used. Preference is given to alcohols, in particular C₁-C₁₀-alcohols and also C₁-C₁₀-alcohols, the carbon chain of which is interrupted by ether groups. By way of example, mention may be made of methanol, ethanol, n- and isopropanol, n-, iso- and tert-butanol, 2-ethylhexanol and methyl diglycol. Depending on the selection of the compound reactive with the isocyanate groups, it is possible to influence the hydrophobicity and the viscosity of the resulting urethane- or urea-containing carbodiimides.

The preparation of the carbodiimides through reaction of diisocyanates can be condensed at elevated temperatures, e.g. at temperatures from 50 to 250° C., preferably from 100 to 200° C., expediently in the presence of catalysts with the elimination of carbon dioxide. Processes suitable for this are described for example in GB-A-1 083 410, DE-A 1 130 594 and DE-A-11 56 401.

Catalysts that have proven successful are primarily e.g. phosphorus compounds, which are preferably selected from the group of phospholenes, phospholene oxides, phospholidines and phospholine oxides. If the reaction mixture has the desired content of NCO groups, the polycarbodiimide formation is usually ended. For this, the catalysts can be distilled off under reduced pressure or be deactivated by adding a deactivator, such as e.g. phosphorus trichloride. The polycarbodiimide production can also be carried out in the absence or presence of solvents that are inert under the reaction conditions.

Through appropriate selection of the reaction conditions, such as e.g. the reaction temperature, the type of catalyst and the amount of catalyst, and also the reaction time, the person skilled in the art can adjust the degree of condensation in the usual manner. The course of the reaction can be monitored most easily by determining the NCO content.

Preference is given to oligocarbodiimides with a residual content of isocyanate groups of <1% by weight, preferably <0.1% by weight, in particular <0.01% by weight, determined by means of end-group analysis. Very particularly preferably, isocyanate groups can no longer be detected by means of end-group analysis.

The reaction of the terminal isocyanate groups that are optionally still present should take place before or during the preparation of the oil-in-water emulsion (process step a).

Aliphatic, cycloaliphatic, araliphatic and aromatic isocyanates are suitable for producing the oligocarbodiimides.

Suitable aromatic diisocyanates are for example 2, 2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethyldiphenyl diisocyanate, 1,2-diphenylethane diisocyanate and phenylene diisocyanate.

Aliphatic and cycloaliphatic diisocyanates comprise for example tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methyl-2,4- and/or 2,6-cyclohexane diisocyanate and/or 4,4′-, 2,4′- and/or 2,2′-dicyclohexylmethane diisocyanate.

Suitable araliphatic isocyanates are e.g. the isomers of tetramethylxylylene diisocyanate.

Examples of higher-functional isocyanates are triisocyanates, e.g. triphenylmethane 4,4′,4″-triisocyanate, also the isocyanurates of the aforementioned diisocyanates, and the oligomers obtainable by partial reaction of diisocyanates with water, e.g. the biurets of the aforementioned diisocyanates, also oligomers which are obtainable by targeted reaction of diisocyanates with polyols which have on average more than 2 and preferably 3 or more hydroxy groups.

It is also possible to use the distillation residues having isocyanate groups that are produced in the industrial production of isocyanate, if appropriate dissolved in one or more of the aforementioned polyisocyanates. It is also possible to use any desired mixtures of the aforementioned polyisocyanates.

Suitable modified, aliphatic isocyanates are e.g. those based on hexamethylene 1,6-diisocyanate, m-xylylene diisocyanate, 4,4′-diisocyanate dicyclohexylmethane and isophorone diisocyanate, which have at least two isocyanate groups per molecule.

Also suitable are e.g. polyisocyanates based on derivatives of hexamethylene 1,6-diisocyanate with biuret structure, as described in DE-B 1 101 394, DE-B 1 453 543, DE-A 1 568 017 and DE-A 1 931 055.

It is also possible to use polyisocyanate-polyuretonimines, as are formed by carbodiimidization of hexamethylene 1,6-diisocyanate comprising biuret groups with organophosphorus catalysts, where carbodiimide groups formed primarily react with further isocyanate groups to give uretonimine groups.

It is also possible to use isocyanurate-modified polyisocyanates with more than two terminal isocyanate groups, e.g. those the preparation of which based on hexamethylene diisocyanate is described in DE-A 2 839 133. Other isocyanurate-modified polyisocyanates can be obtained analogously to this.

It is also possible to use mixtures of the specified isocyanates, e.g. mixtures of aliphatic isocyanates, mixtures of aromatic isocyanates, mixtures of aliphatic and aromatic isocyanates, in particular mixtures which comprise optionally modified diphenylmethane diisocyanates.

The di- and/or polyisocyanates described here can also be used as mixtures with di- and polycarbonyl chlorides, such as sebacoyl chloride, terephthaloyl chloride, adipoyl dichloride, oxalyl dichloride, tricarballylyl trichloride and 1,2,4,5-benzenecarbonyl tetrachloride, with di- and polysulfonyl chlorides, such as 1,3-benzenesulfonyl dichloride and 1,3,5-benzenesulfonyl trichloride, phosgene and with dichloro- and polychloroformic esters, such as 1,3,5-benzenetrichloroformate and ethylenebischloroformate.

Furthermore, it is possible to use, for example, oligo- or polyisocyanates which can be prepared from the specified di- or polyisocyanates or mixtures thereof through linkage by means of urethane, allophanate, urea, biuret, uretdione, amide, isocyanate, carbodiimide, uretonimine, oxadiazinetrione or iminooxadiazinedione structures.

Preferred isocyanates are aromatic, aliphatic and cycloaliphatic and araliphatic isocyanates, and their mixtures, in particular hexamethylene diisocyanate, isophorone diisocyanate, o- and m-tetramethylxylylene diisocyanate, methylenediphenyl diisocyanate and tolylene diisocyanate, and their mixtures.

The second component (II) of the capsule wall formation is the di- and/or polycarboxylic acid. Di- and/or polycarboxylic acids can be used in their acid form and also in the form of a water-soluble salt. Water-soluble is to be understood here as meaning a solubility of the salt of the carboxylic acid of ≧25 g/l. Suitable salts are preferably the alkali metal and/or ammonium salts of the di- and/or polycarboxylic acids. Advantageous alkali metal salts are salts with lithium, sodium or potassium cations. Suitable ammonium salts are the neutralization products of the acids with ammonia, primary, secondary or tertiary amines.

Suitable amines are for example alkylamines, the alkyl radicals of which may in each case be substituted by one or two hydroxy groups and/or interrupted by one or two oxygen atoms in ether function. Particularly preference is given to mono-, di- and trialkanolamines. Preferred alkylamines are triethylamine, diethylamine, ethylamine, trimethylamine, dimethylamine, methylamine, ethanolamine, diethanolamine, triethanolamine, dimethylethanolamine, N-methyldiethanolamine, monomethylethanolamine, 2-(2-aminoethoxy)ethanol and aminoethylethanolamine, and their mixtures. Particular preference is given to ethanolamine, in particular diethanolamine and triethanolamine, and their mixtures.

For di- and/or polycarboxylic acids with a solubility in water of 5≦g/l, the acids are preferably reacted with the amount of amine until complete dissolution in water has taken place. Usually, up to 1.2 base equivalents are used per free acid group.

The equilibrium of free acid and the acid anion is established depending on the pH of the aqueous phase. It is also possible to use acids with a low solubility in water which react in the wall-formation reaction to the degree to which they dissolve.

Dicarboxylic acids suitable according to the invention are saturated dicarboxylic acids, preferably of the general formula HOOC—(CH₂)ₙ—COON, where n is an integer from 0 to 12. Likewise of suitability are alicyclic dicarboxylic acids, unsaturated dicarboxylic acids and aromatic dicarboxylic acids. By way of example, mention may be made of oxalic acid, malonic acid, succinic acid, adipic acid, hexahydrophthalic acid, fumaric acid, maleic acid, phthalic acid and terephthalic acid. Preference is given to saturated dicarboxylic acids in particular having in total 2 to 8 carbon atoms.

Polycarboxylic acids are to be understood as meaning carboxylic acids having more than two carboxylic acid radicals, which may be low molecular weight, such as citric acid, trimellitic acid and pyromellitic acid, or high molecular weight.

Within the context of this application, high molecular weight polycarboxylic acids are to be understood as meaning polycarboxylic acids with an average molecular weight of from 2000 g/mol to 300 000 g/mol. These are preferably polymers based on acrylic acid and/or methacrylic acid, such as polyacrylic acid or polymethacrylic acid or copolymers thereof of ethylenically unsaturated compounds copolymerizable therewith.

The high molecular weight polycarboxylic acids may be homopolymers of monoethlyenically unsaturated mono- and dicarboxylic acids having 3 to 8 or 4 to 8 carbon atoms.

High molecular weight polycarboxylic acids may also be copolymers of monoethlyenically unsaturated mono- and dicarboxylic acids with further ethylenically unsaturated compounds.

Preferred high molecular weight polycarboxylic acids are composed of
20 to 100 mol % of at least one monomer A, selected from monoethylenically unsaturated mono- and dicarboxylic acids having 3 to 8 or 4 to 8 carbon atoms; if appropriate
up to 80 mol % of at least one monomer B, which is an ethylenically unsaturated compound that is insoluble in water or has limited solubility in water, and if appropriate
up 30 mol %, preferably up to 20 mol %, of a monomer C different from the monomers A and B,
   in each case based on the sum of the monomers A, B and C.

The high molecular weight polycarboxylic acids used are preferably homopolymers of acrylic acid and methacrylic acid.

According to a further embodiment, preference is given to high molecular weight polycarboxylic acids which are composed of
5 to 70 mol %, in particular 10 to 60 mol %, of at least one monomer A, selected from monoethylenically unsaturated mono- and dicarboxylic acids having 3 to 8 or 4 to 8 carbon atoms;
30 to 95 mol %, in particular 40 to 90 mol %, of at least one monomer B, which has an ethylenically unsaturated compound that is insoluble in water or has limited solubility in water, and if appropriate
up to 30 mol %, preferably up to 20 mol %, of a monomer C different from monomers A and B,
   in each case based on the sum of the monomers A, B and C.

Examples of monomers A are acrylic acid, methacrylic acid, crotonic acid, vinylacetic acid, 2-ethylacrylic acid, 2-acryloxyacetic acid, 2-acrylamidoacetic acid, maleic acid, maleic acid mono-C₁-C₄-alkyl esters, such as monomethyl maleate and monobutyl maleate, fumaric acid, fumaric acid mono-C₁-C₄-alkyl esters, such as monomethyl fumarate and monobutyl fumarate, itaconic acid and 2-methylmaleic acid. Preferred monomers A are acrylic acid, methacrylic acid and maleic acid, which may also be used in the form of their anhydride for the preparation of the polycarboxylic acid. The specified acids can be completely or partially neutralized before, during or after the polymerization.

Monomers B with limited solubility in water are those which have a solubility in water of up to 80 g/l (at 25° C. and 1 bar). They determine the hydrophobic character of the polycarboxylic acid. As a rule, monomers of this type have at least one C₁-C₅₀-alkyl group. Examples of suitable monomers B are:
vinylaromatic monomers such as styrene, vinyltoluene, tert-butylstyrene and α-methylstyrene, in particular styrene;
vinyl and allyl esters of aliphatic monocarboxylic acids having 2 to 20 carbon atoms, such as vinyl acetate, vinyl propionate, vinyl pivalate, vinyl versatate, vinyl laurate and vinyl stearate;
C₁-C₂₀-alkyl and C₅-C₁₀-cycloalkyl esters of the aforementioned ethylenically unsaturated mono- and dicarboxylic acids, in particular of acrylic acid and of methacrylic acid. Preferred esters are methyl methacrylate, ethyl methacrylate, n-butyl methacrylate, tert-butyl methacrylate, isobutyl methacrylate, n-hexyl methacrylate, cyclohexyl methacrylate, 2-ethylhexyl methacrylate, methyl acrylate, ethyl acrylate, n-butyl acrylate, tert-butyl acrylate, isobutyl acrylate, cyclohexyl acrylate, 2-ethylhexyl acrylate, 2-propylheptyl acrylate, decyl acrylate, lauryl acrylate, stearyl acrylate, 2-ethylhexyl methacrylate, 2-propylheptyl methacrylate, decyl methacrylate, lauryl methacrylate and stearyl methacrylate;
mono- and di-C₁-C₂₀-alkylamides of the aforementioned ethylenically unsaturated mono- and dicarboxylic acids, in particular of acrylic acid and of methacrylic acid, e.g. N-tert-butylacrylamide and N-tert-butylmethacrylamide;
C₃-C₅₀-olefins such as propene, 1-butene, isobutene, 2-methylbutene, 1-pentene, 2-methylpentene, 1-hexene, 2-methylhexene, 1-octene, isooctene, 2,4,4-trimethylpentene (diisobutene) and ethylenically unsaturated oligomeric butenes having 12 to 32 carbon atoms, and also ethylenically unsaturated oligomeric isobutenes having 12 to 32 carbon atoms.

Preferred monomers B are vinylaromatic monomers, in particular styrene, and C₃-C₅₀-olefins.

Suitable monomers C are preferably monoethylenically unsaturated monomers. Of suitability in particular are neutral monomers C which have a solubility in water above 80 g/l (at 25° C. and 1 bar). Examples of such monomers are the amides of the aforementioned ethylenically unsaturated monocarboxylic acids such as acrylamide and methacrylamide, N-vinyllactams such as N-vinylpyrrolidone and N-vinylcaprolactam, hydroxyalkyl esters of the aforementioned monoethylenically unsaturated carboxylic acids, such as hydroxyethyl acrylate, hydroxypropyl acrylate, hydroxybutyl acrylate, hydroxyethyl methacrylate, hydroxypropyl methacrylate, hydroxybutyl methacrylate and the esters of acrylic acid or of methacrylic acid with oligoalkylene oxides such as oligoethylene oxide or oligopropylene oxide with degrees of oligomerization in the range from 2 to 200.

It has been observed that in general molecular weights above 20 000 are advantageous, preferably M_{w}>80 000. However, high molecular weights can reduce the solubility of the polycarboxylic acid or salts thereof in such a way that a slowing of the wall formation is observed.

Naturally, not all of the acid groups in the polymer have to be present in neutralized form. As a rule, a degree of neutralization of 50% of all of the acid groups present in the polymer suffices. In particular, the degree of neutralization is 80 to 100%. Suitable counterions are the sodium, potassium and ammonium ions.

According to one preferred variant, high molecular weight polycarboxylic acids, if appropriate in a mixture with one or more dicarboxylic acids, are used as component (II). Preferably, 10 to 90, in particular 30 to 70% by weight of high molecular weight polycarboxylic acid, based on the total amount of di- and polycarboxylic acids, is used.

On account of their poor solubility in water, high molecular weight polycarboxylic acids are generally used as salts, or mixtures of acid or salt preferably of the aforementioned amines, preferably alkylamines. Often, as a result of the synthesis, the high molecular weight polycarboxylic acids are often already partly present in the form of their salts.

The amount of the oligocarbodiimide to be used according to the invention and of the di- and/or polycarboxylic acid or salts thereof varies within the scope customary for interfacial polyaddition processes.

The carbodiimides are usually used in amounts of from 2 to 40% by weight, based on the sum of capsule core and capsule wall, preferably from 5 to 25% by weight.

The theoretic amount of the di- and/or polycarboxylic acid, or salts thereof, necessary for the wall formation is calculated from the content of carbodiimide groups and the total mass of desired polymer shell around the microcapsule core.

At least the theoretically equivalent number of acid groups is required for the reaction of all of the carbodiimide groups present in the oil phase. It is therefore advantageous to use the oligocarbodiimide and the di- and/or polycarboxylic acid, or salts thereof, in the ratio of their equivalent weights. However, it is likewise possible to use an excess or deficit of the di- and/or polycarboxylic acid or salts thereof of the stoichiometrically calculated di- and/or polycarboxylic acid or salts thereof.

In particular, therefore, di- and/or polycarboxylic acid or salts thereof are used in an amount which is between 100 and 1000% by weight of that calculated theoretically. Preferably, this amount is between 100 and 300% by weight, based on the theoretically calculated amount.

In order to obtain a stable emulsion, surface-active substances such as polymeric protective colloids are generally required. As a rule, surface-active substances which mix with the hydrophilic phase are used.

As a rule, the microcapsules are prepared in the presence of at least one organic protective colloid. These protective colloids may be ionic or neutral. Protective colloids can be used here either individually or else in mixtures of two or more identically or differently charged protective colloids.

Preference is given to using organically neutral protective colloids. Organic protective colloids are preferably water-soluble polymers which ensure the formation of closed capsule walls, and also form microcapsules with preferred particle sizes in the range from 0.5 to 50 μm, preferably 0.5 to 30 μm, in particular 0.5 to 10 μm.

Organic neutral protective colloids are, for example, cellulose derivatives such as hydroxyethylcellulose, methylhydroxyethylcellulose, methylcellulose and carboxymethylcellulose, polyvinylpyrrolidone, copolymers of vinylpyrrolidone, gelatin, gum arabic, xanthan, casein, polyethylene glycols, polyvinyl alcohol and partially hydrolyzed polyvinyl acetates, and methylhydroxypropylcellulose. Preferred organic neutral protective colloids are polyvinyl alcohol and partially hydrolyzed polyvinyl acetates, and also methylhydroxypropylcellulose preferably in combination.

Polyvinyl alcohol is obtainable by polymerization of vinyl acetate, if appropriate in the presence of comonomers, and hydrolysis of the polyvinyl acetate with elimination of the acetyl groups to form hydroxy groups. The degree of hydrolysis of the polymers can be for example 1 to 100% and is preferably in the range from 50 to 100%, in particular from 65 to 95%. Within the context of this application, partially hydrolyzed polyvinyl acetates are understood as meaning a degree of hydrolysis of <50%, and polyvinyl alcohol is understood as meaning from 50 to 100%. The preparation of homopolymers and copolymers of vinyl acetate, and the hydrolysis of these polymers to form polymers comprising vinyl alcohol units is generally known. Polymers comprising vinyl alcohol units are sold for example as Mowiol® grades from Kuraray Specialities Europe (KSE).

Preference is given to polyvinyl alcohols or partially hydrolyzed polyvinyl acetates, the viscosity of which for a 4% strength by weight aqueous solution at 20° C. in accordance with DIN 53015 has a value in the range from 3 to 56 mPa·s, preferably a value from 14 to 45 mPa·s. Preference is given to polyvinyl alcohols with a degree of hydrolysis of ≧65%, preferably 70%, in particular ≧75%.

Hydroxypropylcelluloses are likewise advantageous, as sold as Culminal® grades from Hercules GmbH, Düsseldorf. Preference is given to hydroxypropylcelluloses with a viscosity of the 2% strength by weight solution at 20° C. of from 25 to 16 000 mPas, preferably 40-600, particularly preferably 90-125 mPas (viscosity in accordance with Brookfield RVT).

In general, polyvinyl alcohol or partially hydrolyzed polyvinyl acetate or mixtures of these with hydroxypropylcelluloses are used in a total amount of at least 3% by weight, preferably from 3.5 to 8% by weight, based on the microcapsules (without protective colloid). Here, it is possible to add further aforementioned protective colloids in addition to the preferred amounts of polyvinyl alcohol or partially hydrolyzed polyvinyl acetate or hydroxypropylcellulose. Preferably, the microcapsules are prepared only with polyvinyl alcohol and/or partially hydrolyzed polyvinyl acetate and/or hydroxypropylcellulose, without the addition of further protective colloids.

In general, the protective colloids are used in amounts of from 0.1 to 15% by weight, preferably from 0.5 to 10% by weight, based on the water phase. For inorganic protective colloids, amounts of from 0.5 to 15% by weight, based on the water phase, are preferably selected. Organic protective colloids are preferably used in amounts of from 0.1 to 10% by weight, based on the water phase of the emulsion.

In addition, it is possible, for costabilization, to add surfactants, preferably nonionic surfactants. Suitable surfactants can be found in the “Handbook of Industrial Surfactants”, to the contents of which reference is expressly made. The surfactants can be used in an amount of from 0.01 to 10% by weight, based on the water phase of the emulsion.

With the help of the protective colloid, a stable emulsion of core material and oligocarbodiimide in water is prepared with stirring. In this case, stable means that it does not result in a doubling of the average droplet size within one hour.

As a rule, the emulsion is formed at a neutral pH of the water phase, but may also be acidic or alkaline depending on the core material.

Preferably, the dispersing conditions for producing the stable oil-in-water emulsion are selected in a manner known per se such that the oil droplets have the size of the desired microcapsules. Small capsules, particularly if the size is to be below 50 μm, require homogenizing or dispersing machines, in which case these instruments may be provided with or without a forced-flow device.

The homogenization can also take place using ultrasound (e.g. Branson Sonifier II 450). For homogenization by means of ultrasound, for example, the devices described in GB 2250930 and U.S. Pat. No. 5,108,654 are suitable.

The capsule size can be controlled within certain limits via the rotational speed of the dispersing device/homogenizing device and/or with the help of the concentration of the protective colloid or via its molecular weight, i.e. via the viscosity of the aqueous continuous phase. Here, as the rotational speed increases up to a limiting rotational speed, the size of the dispersed droplets decreases.

In this connection, it is important the dispersing devices are used at the start of capsule formation. In the case of continuously operating devices with forced flow, it is advantageous to send the emulsion several times through the shear field.

To disperse highly viscous thermally stable media, the preparation of the emulsion takes place in a temperature range from 30 to 130° C., preferably 40 to 100° C.

According to one preferred variant, the di- and/or polycarboxylic acid, preferably the high molecular weight polycarboxylic acid, and/or salts thereof is added to the emulsion of core material and oligocarbodiimide in water. As a rule, as a result of the addition, the interfacial polymerization starts and with it the wall formation. The di- and/or polycarboxylic acid and/or salts thereof can be metered in here without a diluent or likewise as aqueous solution. As a rule, a 25 to 40% strength by weight, preferably 5 to 20% strength by weight, aqueous solution is selected.

Depending on the reactivity of the carbodiimides, a further process variant is possible. According to this variant, for less reactive carbodiimides, it is possible to co-emulsify the di- and/or oligocarboxylic acid and/or salts thereof and to start the reaction by increasing the temperature.

The interfacial polymerization can proceed for example at temperatures in the range from −3 to +98° C., preference being given to working at 10 to 95° C. The dispersion and polymerization temperature should of course be above the melting temperature of the core material if the core material is not present as solution or suspension.

As a rule, the polymerization is carried out at 20 to 100° C., preferably at 40 to 95° C. Depending on the desired core material, the oil-in-water emulsion is to be formed at a temperature at which the core material is liquid/oily.

The addition of the di- and/or polycarboxylic acid and/or salts thereof generally takes place over a period of 20 to 120 minutes.

The addition of component (II) can take place either continuously or discontinuously.

Following the addition of component (II), it is advisable to keep the reaction mixture in a temperature range from 40 to 100° C. for a further 1 to 8 hours in order, if appropriate, to complete the reaction.

By adding the carboxylic acid or the carboxylic acid salts and as a result of their reaction with the carbodiimides, the pH changes during the reaction. The starting pH of the water phase of the oil-in-water emulsion is generally neutral. The aqueous dicarboxylic acid solutions generally have a pH in the range from 3 to 6. By contrast, the polycarboxylic acid solutions or part salts generally have a pH in the range from 4 to 6. Solutions of the salts of di- and/or polycarboxylic acids generally have a pH of >7. It has now been observed that in the weakly acidic to neutral or basic pH range, the wall-formation reaction proceeds relatively slowly, and it is advantageous to additionally acidify the reaction mixture with a mineral acid.

According to one preferred variant, the process for the preparation of the microcapsules comprises the process steps:
a) preparation of an oil-in-water emulsion with a disperse phase which comprises the core material and an oligocarbodiimide, an aqueous continuous phase and a protective colloid;
b) addition of an aqueous solution of a high molecular weight polycarboxylic acid in the form of its salt to the emulsion prepared in a)
c) acidification of the mixture with a mineral acid, preferably to a pH in the range from 3 to 1.

It has been found that, following this process, capsules are obtained which are characterized by improved stability.

Suitable mineral acids are hydrochloric acid, nitric acid, phosphoric acid and in particular sulfuric acid.

The amount of mineral acid can be selected by continually measuring the pH during the addition such that an end pH of 1-3 is achieved.

Furthermore, the order of the addition of component (II) and of the mineral acid is not particularly uncritical. The component (II) can be added to the emulsion or be metered in over a period of time. It is likewise possible to add the mineral acid in its entirety or to meter it in over a period of time.

According to one preferred variant, at temperatures of the reaction mixture up to 40° C., firstly the total amount of component (II) is added and then the total amount of mineral acid is added.

At temperatures of the reaction mixture above 40° C., the total amount of component (II) is preferably added and then the mineral acid is metered in, preferably over a period of from 20 to 120 minutes.

In this way, it is possible to produce microcapsules with an average particle size in the range from 0.5 to 100 μm, it being possible to adjust the particle size in a manner known per se via the shear force, the stirring speed, the protective colloid and its concentration. Preference is given to microcapsules with an average particle size in the range from 0.5 to 50 μm, preferably 0.5 to 30 μm (centrifugal average by means of light scattering). According to the process of the invention, it is possible to produce microcapsule dispersions with a content of from 5 to 50% by weight of microcapsules. The microcapsules are individual capsules.

The average particle diameter is the weight-average particle diameter, determined by Fraunhofer diffraction.

The microcapsules according to the invention can preferably be processed directly as aqueous dispersion. A spray-drying to give a microcapsule powder is generally possible, but has to take place gently.

According to one embodiment, microcapsules according to the invention with catalysts and/or inhibitors as core materials are suitable in chemical synthesis or in polymerization.

Depending on the core material, the microcapsules according to the invention are suitable for copy papers, in cosmetics, for the encapsulation of adhesives, adhesive components, catalysts or in crop protection or generally for the encapsulation of biocides. Microcapsules with core materials from group p) are suitable as crosslinkers in adhesives, paints, coatings, paper coating slips or other coating or impregnation compositions. The microcapsules according to the invention are particularly suitable for crop protection.

Furthermore, the microcapsules according to the invention with a capsule core material from groups a) to h), provided it passes through a solid/liquid phase change (PCM material) in the range from −20 to 100° C., are suitable as latent heat storage media. The fields of use of microencapsulated phase change materials are generally known. Thus, the microcapsules according to the invention can advantageously be used for modifying fibers and textile articles, for example textile fabrics and nonwovens (e.g. batts) etc. Application forms to be mentioned here are in particular microcapsule coatings, foams containing microcapsules and microcapsule-modified textile fibers. The production of microcapsule coatings is described for example in WO 95/34609, to which reference is expressly made. The modification of foams containing microcapsules takes place in a similar manner, as described in DE 981576T and U.S. Pat. No. 5,955,188. A further processing option is the modification of the textile fibers themselves, e.g. by spinning from a melt or an aqueous dispersion, as described in US 2002/0054964.

A further broad field of application is binding construction materials with mineral, silicatic or polymeric binders. A distinction is made here between moldings and coating compositions.

A mineral molding is understood here as meaning a molding which is formed from a mixture of a mineral binder, water, aggregates and, if appropriate, auxiliaries after shaping as a result of the mineral binder/water mixture as a function of time, if appropriate under the action of elevated temperature. Mineral binders are generally known. These are finely divided inorganic substances such as lime, gypsum, clay, loam and/or cement, which are converted to their ready-to-use form by stirring with water, the latter, when left to themselves, in the air or else under water, if appropriate under the action of elevated temperature, solidifying in a stone-like manner as a function of time.

The aggregates generally consist of granular or fiber-like natural or synthetic stone (gravel, sand, glass fibers or mineral fibers), in special cases also of metals or organic aggregates or of mixtures of said aggregates, having particle sizes or fiber lengths which are adapted to the particular intended use in a manner known per se.

Suitable auxiliaries are in particular those substances which accelerate or delay hardening or which influence the elasticity or porosity of the consolidated mineral molding.

The microcapsules according to the invention are suitable for the modification of mineral binding construction materials (mortar-like preparations) which comprise a mineral binder which consists of 70 to 100% by weight of cement and 0 to 30% by weight of gypsum. This is the case particularly if cement is the sole mineral binder, the effect being independent of the type of cement. As regards further details, reference may be made to DE-A 196 23 413. Typically, the dry compositions of mineral binding construction materials comprise 0.1 to 20% by weight of microcapsules, based on the amount of mineral binder.

Furthermore, the microcapsules according to the invention can be used as additive in mineral coating compositions such as interior or exterior plaster. Such a plaster for the interior sector is usually composed of gypsum as binder.

Coatings for the exterior sector such as external facades or wet rooms can comprise cement (cementitious plasters), lime or waterglass (mineral or silicate plasters) or plastics dispersions (synthetic resin plasters) as binders together with fillers and, if appropriate, pigments for imparting color.

In addition, the microcapsules according to the invention with PCM materials are suitable for modifying gypsum construction boards. The production of gypsum construction boards with microencapsulated latent heat storage materials (PCM) is generally known and described in EP-A 1 421 243, to which reference is expressly made. In this connection, instead of cardboard based on cellulose, it is possible to use alternative, fibrous structures, preferably glass fibers, as coverings for both sides of the “gypsum construction board”. The alternative materials can be used as wovens and as so-called “nonwovens”, i.e. as web-like structure. Construction boards of this type are known for example from U.S. Pat. No. 4,810,569, U.S. Pat. No. 4,195,110 and U.S. Pat. No. 4,394,411.

Furthermore, the microcapsules according to the invention with PCM materials are suitable as additive in polymeric or lignocellulose-containing moldings, such as chipboards or for polymeric coating compositions.

In addition, the microcapsule dispersions according to the invention with PCM materials are suitable as heat transfer liquid.

Depending on the field of use, further auxiliaries, or in the case of multicomponent adhesives, the customary components, if appropriate also in encapsulated form, can be added to the microcapsule dispersions according to the invention. Auxiliaries may be, for example, slip additives, adhesion promoters, flow agents, film-forming auxiliaries, flame retardants, corrosion inhibitors, waxes, siccatives, matting agents, deaerating agents, thickeners and water-soluble biocides. Substrates coated with such microcapsule dispersions are storage-stable, i.e. even after a storage period of several weeks, the coated substrate can be processed with just as good results.

The present invention further relates to an agrochemical formulation comprising the microcapsules according to the invention. The agrochemical formulation according to the invention usually comprises formulation auxiliaries, the choice of auxiliaries usually being governed by the specific application form and/or the agrochemical active ingredient. Examples of suitable formulation auxiliaries are additional solvents, surfactants and other surface-active substances (such as solubilizers, protective colloids, wetting agents and adhesives), adjuvants, organic and inorganic thickeners, bactericides, antifreezes, antifoams, dyes and stickers (e.g. for seed treatment).

Suitable additional solvents which may additionally be present in the agrochemical formulation are organic solvents such as mineral oil fractions of moderate to high boiling point, such as kerosene and diesel oil, also coal tar oil, and also oils of vegetable or animal origin, aliphatic, cyclic and aromatic hydrocarbons, e.g. paraffins, tetrahydronaphthalene, alkylated naphthalenes and derivatives thereof, alkylated benzenes and derivatives thereof, alcohols such as methanol, ethanol, propanol, butanol, benzyl alcohol and cyclohexanol, glycols, ketones such as cyclohexanone, gamma-butyrolactone, dimethyl fatty acid amides, fatty acids and fatty acid esters and strongly polar solvents, e.g. amines such as N-methylpyrrolidone. Preference is given to alcohols, such as benzyl alcohol. In principle, it is also possible to use solvent mixtures.

Surfactants can be used individually or in a mixture. Surfactants are compounds which reduce the surface tension of water. Examples of surfactants are ionic (anionic or cationic) and nonionic surfactants.

Suitable surface-active substances (adjuvants, wetting agents, adhesives, dispersants or emulsifiers) in addition to the aforementioned surfactants are the alkali metal, alkaline earth metal, ammonium salts of aromatic sulfonic acids, e.g. of lignosulfonic acid (Borresperse® grades, Borregaard, Norway), phenolsulfonic acid, naphthalenesulfonic acid (Morwet® grades, Akzo Nobel) and dibutylnaphthalenesulfonic acid (Nekal® grades, BASF), and also of fatty acids, alkyl- and alkylarylsulfonates, alkyl, lauryl ether and fatty alcohol sulfates, and also salts of sulfated hexa-, hepta- and octadecanols, and also of fatty alcohol glycol ethers, condensation products of sulfonated naphthalene and its derivatives with formaldehyde, condensation products of naphthalene or of naphthalenesulfonic acids with phenol and formaldehyde, polyoxyethylene octylphenol ether, ethoxylated isooctyl-, octyl- or nonylphenol, alkylphenyl, tributylphenyl polyglycol ethers, alkylaryl polyether alcohols, isotridecyl alcohol, fatty alcohol ethylene oxide condensates, ethoxylated castor oil, polyoxyethylene or polyoxypropylene alkyl ethers, lauryl alcohol polyglycol ether acetate, sorbitol ester, lignosulfite waste liquors, and also proteins, denatured proteins, polysaccharides (e.g. methylcellulose), hydrophobically modified starches, polyvinyl alcohol (Mowiol® grades, Clariant), polycarboxylates (Sokalan® grades, BASF), polyalkoxylates, polyvinylamine (Lupamin® grades, BASF), polyethyleneimine (Lupasol® grades, BASF), polyvinylpyrrolidone and copolymers thereof.

Examples of adjuvants are organically modified polysiloxanes, such as BreakThruS 240®; alcohol alkoxylates, such as Atplus® 245, Atplus® MBA 1303, Plurafac® LF and Lutensol® ON; EO-PO block polymers, e.g. Pluronic® RPE 2035 and Genapol® B; alcohol ethoxylates, e.g. Lutensol® XP 80; and sodium dioctylsulfosuccinate, e.g. Leophen® RA.

Examples of thickeners (i.e. compounds which confer modified flow behavior on the composition, i.e. high viscosity in the resting state and low viscosity in the agitated state) are polysaccharides, and also organic and inorganic sheet minerals such as xanthan gum (Kelzan®, CP Kelco), Rhodopol® 23 (Rhodia) or Veegum® (R.T. Vanderbilt) or Attaclay® (Engelhard Corp.).

For stabilization, bactericides can be added to the composition. Examples of bactericides are those based on dichlorophen and benzyl alcohol hemiformal (Proxel® from ICI or Acticide® RS from Thor Chemie and Kathon® MK from Rohm & Haas), and also isothiazolinone derivatives such as alkylisothiazolinones and benzisothiazolinones (Acticide® MBS from Thor Chemie).

Examples of suitable antifreezes are ethylene glycol, propylene glycol, urea and glycerol.

Examples of antifoams are silicone emulsions (such as e.g. Silikon® SRE, Wacker, Germany or Rhodorsil®, Rhodia, France), long-chain alcohols, fatty acids, salts of fatty acids, organofluorine compounds and mixtures thereof.

The agrochemical formulation according to the invention is in most cases diluted prior to use in order to produce the so-called tank mix. Of suitability for the dilution are mineral oil fractions of moderate to high boiling point, such as kerosene or diesel oil, also coal tar oils, and also oils of vegetable or animal origin, aliphatic, cyclic and aromatic hydrocarbons, e.g. toluene, xylene, paraffin, tetrahydronaphthalene, alkylated naphthalenes or derivatives thereof, methanol, ethanol, propanol, butanol, cyclohexanol, cyclohexanone, isophorone, strongly polar solvents, e.g. dimethyl sulfoxide, N-methylpyrrolidone or water. Preference is given to using water. The diluted composition is usually applied by spraying or misting. Oils of various types, wetting agents, adjuvants, herbicides, bactericides, fungicides can be added to the tank mix directly prior to application (tank mix). These agents can be admixed into the compositions according to the invention in the weight ratio 1:100 to 100:1, preferably 1:10 to 10:1. The pesticide concentration in the tank mix can be varied within relatively large ranges. In general, they are between 0.0001 and 10%, preferably between 0.01 and 1%. When used in crop protection, the application rates are between 0.01 and 2.0 kg of active ingredient per ha depending on the nature of the desired effect.

The present invention also relates to the use of an agrochemical formulation according to the invention for controlling phytopathogenic fungi and/or undesired plant growth and/or undesired insect or mite infestation and/or for regulating the growth of plants, where the composition is allowed to act on the particular pests, their habitat or the plants to be protected from the particular pest, the soil and/or on undesired plants and/or the useful plants and/or their habitat.

The present invention has various advantages, particularly when compared with conventional polyurethane capsules which are produced in aqueous dispersion from isocyanate in the oil phase and amine in the water phase: the process according to the invention does not use any toxic isocyanates; no undesired by-products can arise as a result of reaction of the water-sensitive isocyanates with the aqueous phase of the dispersion; and whereas polyurethane capsules are produced from isocyanates on an industrial scale in continuous processes, with the present process, simpler and cost-effective batch processes are now also possible.

The examples below serve to illustrate the invention in more detail. In the examples, the percentages are percent by weight, unless stated otherwise.

### EXAMPLES

### A) Preparation of the Carbodiimide

300 g of a TMXDI-based carbodiimide with an NCO content of 7.2% by weight prepared according to the teaching of the examples of DE-A14 318 979 were heated to 100° C. and reacted with 67 g (0.514 mol) of 2-ethylhexanol until the NCO content had dropped to <0.01%. This gave a slightly yellowish colored oil with a calculated NCN content of 12.3% by weight.

### Example 1

Water phase

| | |
|---|---|
| 200 g | of dem. (demineralized) water |
| 145 g | of a 5% strength by weight solution of |
| | methylhydroxypropylcellulose (Culminal MHPC 100) |
| 36 g | of a 10% strength by weight aqueous polyvinyl alcohol |
| | solution (degree of hydrolysis: 79%, Mowiol ® 15-79) |

Oil phase

| | |
|---|---|
| 289 g | of diisopropylnaphthalene, isomer mixture |
| 32.1 g | of the carbodiimide obtained from example A) |
| 1 g | of Pergascript ® Red I 6 B (leucobase of a color former, |
| | Ciba Specialty Chemicals) |

Feed

| | |
|---|---|
| 167.3 g | of a 10.4% strength by weight solution of malonic acid |
| | in dem. water |

### Procedure:

The above water phase was introduced as initial charge at room temperature. After adding the oil phase, the mixture was dispersed using a high-speed dissolver stirrer for 10 min at 40° C. and 4500 rpm. This gave a stable emulsion with a particle size 2 to 12 μm in diameter. The emulsion was heated to 80° C. with stirring using an anchor stirrer, and then the feed was added over the course of 40 minutes. The mixture was held at 80° C. for a further 4 hours and then cooled to room temperature.

This gave a microcapsule dispersion with an average particle size of 5.2 μm (determined by means of Fraunhofer diffraction).

After the microcapsule dispersion had been spread onto a silica gel plate, only a slight red coloration was evident. A slight red coloration is a sign of largely tight capsules. In the case of nontight capsules, the leucobase is able to escape. The acidic silica gel of the plate then protonates the leucobase which, as a result, assumes a red shade. By scratching using a metal spatula, it was possible to show, by reference to the intensive red coloration, that the capsules can be destroyed mechanically and release the color former upon mechanical stress.

### Example 2

Water phase

| | |
|---|---|
| 200 g | of dem. (demineralized) water |
| 145 g | of a 5% strength by weight solution of |
| | methylhydroxypropylcellulose (Culminal MHPC 100) |
| 36 g | of a 10% strength by weight aqueous polyvinyl alcohol |
| | solution (degree of hydrolysis: 79%, Mowiol ® 15-79) |

Oil phase

| | |
|---|---|
| 289 g | of diisopropylnaphthalene, isomer mixture |
| 32.1 g | of the carbodiimide obtained from example A) |
| 1 g | of Pergascript ® Red I 6 B (leucobase of a color former, |
| | Ciba Specialty Chemicals) |

Feed

| | |
|---|---|
| 167.3 g | of a 10.4% strength by weight solution of a polyacrylic |
| | acid with an average molecular weight of 3000 g/mol |
| | in dem. water |

### Procedure:

The above water phase was introduced as initial charge at room temperature. After adding the oil phase, the mixture was dispersed using a high-speed dissolver stirrer for 10 min at 40° C. and 4500 rpm. This gave a stable emulsion with a particle size 2 to 12 μm in diameter. The emulsion was heated to 80° C. with stirring using an anchor stirrer, and then the feed was added over the course of 40 minutes. The mixture was held at 80° C. for a further 4 hours and then cooled to room temperature.

This gave a microcapsule dispersion with an average particle size of 4.5 μm (determined by means of Fraunhofer diffraction).

For the thermal determination of the tightness, the capsule dispersion was dried at room temperature and then heated to 130° C. for 1 h. As a result of the heating, a weight loss of 17.6% (based on the dry weight) was measured.

### Example 3

The procedure was analogous to example 2, except that a polyacrylic acid with an average molecular weight of 100 000 g/mol was used.

The thermal tightness determination led to a weight loss of only 7.5%.

### Example 4

Example 2 was reproduced, but using a polyacrylic acid with an average molecular weight of 200 000 g/mol.

The thermal tightness determination led to a weight loss of only 2.2%. The test on silica plates (see example 1) indicated a clearly perceptible red coloration, however.

### Example 5

| | |
|---|---|
| 200 g | of dem. (demineralized) water |
| 145 g | of a 5% strength by weight solution of |
| | methylhydroxypropylcellulose (Culminal MHPC 100) |
| 36 g | of a 10% strength by weight aqueous polyvinyl alcohol |
| | solution (degree of hydrolysis: 79%, Mowiol ® 15-79) |

Oil phase

| | |
|---|---|
| 289 g | of diisopropylnaphthalene, isomer mixture |
| 32.1 g | of the carbodiimide obtained from example A) |
| 1 g | of Pergascript ® Red I 6 B (leucobase of a color former, |
| | Ciba Specialty Chemicals) |

Feed 1

| | |
|---|---|
| 200 g | of an aqueous solution of 17.5 g of a polyacrylic acid with an |
| | average molecular weight of 200 000 g/mol |
| 30 g | of triethanolamine |

Feed 2

| | |
|---|---|
| 119 g | of an aqueous 16.5% strength sulfuric acid solution |

### Procedure:

The above water phase was introduced as initial charge at room temperature. After adding the oil phase, the mixture was dispersed using a high-speed dissolver stirrer for 10 min at 40° C. and 4500 rpm. This gave a stable emulsion with a particle size 2 to 12 μm in diameter. Feed 1 was added and the emulsion was heated to 80° C. with stirring using an anchor stirrer, and then feed 2 was added over the course of 120 minutes. The mixture was held at 80° C. for a further 2 hours and then cooled to room temperature and neutralized with aqueous sodium hydroxide solution.

This gave a microcapsule dispersion with an average particle size of 11.7 μm (determined by means of Fraunhofer diffraction).

After the microcapsule dispersion had been spread onto a silica gel plate, only a slight red coloration was evident.

The thermal tightness determination led to a weight loss of 5.3%.

1. A process for producing microcapsules with a capsule wall and a capsule core, comprising the process steps:
a) preparation of an oil-in-water emulsion with a disperse phase which comprises the core material and an oligocarbodiimide, an aqueous continuous phase and a protective colloid and
b) subsequent reaction of one or more di- and/or polycarboxylic acids and/or water-soluble salts thereof with the oligocarbodiimide,
where the oligocarbodiimide has a residual content of isocyanate groups of <1% by weight, and
where the di- and/or polycarboxylic acid or salts thereof are used in an amount which is between 100 and 1000% by weight of the theoretically calculated amount which is theoretically required to react all of the carbodiimide groups located in the oil phase.

2. A process for producing microcapsules with a capsule wall and a capsule core, comprising the process steps:
a) preparation of an oil-in-water emulsion with a disperse phase which comprises the core material and an oligocarbodiimide, an aqueous continuous phase and a protective colloid;
b) addition of one or more di- and/or polycarboxylic acids and/or water-soluble salts thereof to the emulsion prepared in a).

3. The process for producing microcapsules according to claim 1 or 2, wherein the core material has a solubility in water of <25 g/l.

4. The process for producing microcapsules according to any one of claims 1 to 3, wherein at least one core material is selected from the group comprising aliphatic and aromatic hydrocarbon compounds, saturated or unsaturated C₆-C₃₀-fatty acids, fatty alcohols, C₆-C₃₀-fatty amines, C₄-C₃₀-mono-, C₄-C₃₀-di- and C₄-C₃₀-polyesters, primary, secondary or tertiary C₄-C₃₀-carboxamides, fatty acid esters, natural and synthetic waxes, halogenated hydrocarbons, natural oils, C₃-C₂₀-ketones, C₃-C₂₀-aldehydes, crosslinkers, adhesive resins and tackifying resins, fragrances and aroma substances, active ingredients, dyes, color formers, catalysts and inhibitors.

5. The process for producing microcapsules according to any one of claims 1 to 4, wherein at least one core material is an agrochemical active ingredient.

6. The process for producing microcapsules according to any one of claims 1 to 5, wherein the oligocarbodiimide comprises on average 2 to 20 carbodiimide groups.

7. The process for producing microcapsules according to any one of claims 1 to 6, wherein the oligocarbodiimide has a number-average molecular weight Mₙ of from 100 to 40 000.

8. The process for producing microcapsules according to any one of claims 1 to 7, wherein the di- and/or polycarboxylic acid or salts thereof are used in an amount which is between 100 and 300% by weight of the theoretically calculated amount.

9. The process for producing microcapsules according to any one of claims 1 to 8, wherein the oligocarbodiimide is formed from aromatic, aliphatic and cycloaliphatic and/or araliphatic isocyanates, and their mixtures.

10. The process for producing microcapsules according to any one of claims 1 to 9, wherein, under b), a saturated, alicyclic, unsaturated and/or aromatic dicarboxylic acid and/or salt thereof is added.

11. The process for producing microcapsules according to any one of claims 1 to 10, wherein, under b), a high molecular weight polycarboxylic acid and/or salt thereof is added.

12. The process for producing microcapsules according to claim 11, wherein the high molecular weight polycarboxylic acid used is one or more homopolymers of acrylic acid and methacrylic acid.

13. A microcapsule obtainable by any one of claims 1 to 12.

14. An agrochemical formulation comprising microcapsules obtainable according to any one of claims 1 to 12.

15. The use of the agrochemical formulation according to claim 14 for controlling phytopathogenic fungi and/or undesired plant growth and/or undesired insect or mite infestation and/or for regulating the growth of plants, where the microcapsules or the formulations are allowed to act on the particular pests, their habitat or the plants to be protected from the particular pest, the soil and/or on undesired plants and/or the useful plants and/or their habitat.
